(19) United States
(12) Patent Application Publication
(10) Pub. No.: US 2026/0163382 A1
(43) Pub. Date: Jun. 11, 2026

(54) POWER STATION USING BATTERY PACKS CHARGED BY VEHICLE

(71) Applicant: GA RAM PARK, Seoul (KR)

(72) Inventor: GA RAM PARK, Seoul (KR)

(21) Appl. No.: 19/386,151

(22) Filed: Nov. 11, 2025

(30) Foreign Application Priority Data
Dec. 9, 2024 (KR) 10-2024-0181402

(51) Int. Cl. H02J 7/14; B60L 53/51; B60L 53/53; B60L 53/62; B60L 53/80; H01M 10/42; H01M 10/48; H01M 50/209; H01M 50/249; H01M 50/262; H02J 7/00

(52) U.S. Cl. CPC H02J 7/1423; B60L 53/51; B60L 53/53; B60L 53/62; B60L 53/80; H01M 10/425; H01M 10/488; H01M 50/209; H01M 50/249; H01M 50/262; H02J 7/40; H02J 7/50; H01M 2220/20

(57) ABSTRACT

Provided is a power station using battery packs charged by a vehicle, the power station including: a plurality of battery-mounting ports in which mobile battery packs are mounted; and a station power control part configured to collect power from the plural battery packs and supply the collected power to an external power-receiving means, wherein the battery packs are connected to a vehicle battery that stores power generated by driving of an engine by a generator of a vehicle, and are charged with the power of the vehicle battery.

### CROSS-REFERENCE TO RELATED APPLICATION

This application claims priority to Korean Patent Application No. 10-2024-0181402, filed on Dec. 9, 2024 in the Korean Intellectual Property Office, the disclosure of which is incorporated herein by reference.

### BACKGROUND OF THE DISCLOSURE

### Field of the Disclosure

The present disclosure relates to a power management station using battery packs charged by a vehicle, and more particularly, to a power management station that collects surplus power from power generated by a generator in a vehicle and enables the collected power to be utilized for various purposes.

### Description of the Related Art

In general vehicles, power is generated by a generator when an engine is driven and may be stored in a vehicle battery. The energy stored in the vehicle battery is used for normal operation of the vehicle, for example, to start the vehicle and to operate the vehicle's lighting, air conditioning system, sound system, and the like.

Since power is continuously generated even after the vehicle is started, surplus power is also continuously generated after the power required for the normal operation of the vehicle is generated. When such surplus power is generated, the output of the generator is controlled to prevent the battery from being overcharged, or the surplus power is converted into heat or the like to be dissipated.

Such wasting of the surplus power generated in the vehicle may cause environmental problems due to inefficient use of energy resources, and accordingly, a measure for solving this problem is required.

### RELATED ART DOCUMENTS

### Patent Documents

(Patent Document 1) KR 10-2020-0053734 A
(patent Document 2) KR 10-1542674 B1

### SUMMARY OF THE DISCLOSURE

Therefore, the present disclosure has been made in view of the above problems, and it is an object of the present disclosure to provide a power station that can solve environmental problems caused by an inefficient use of energy resources by collecting surplus power generated in a vehicle and supplying the collected surplus power to an external power-receiving means.

In accordance with an aspect of the present disclosure, the above and other objects can be accomplished by the provision of a power station using battery packs charged by a vehicle, the power station including: a plurality of battery-mounting ports in which mobile battery packs are mounted; and a station power control part configured to collect power from the plural battery packs and supply the collected power to an external power-receiving means, wherein the battery packs are connected to a vehicle battery that stores power generated by driving of an engine by a generator of a vehicle, and are charged with the power of the vehicle battery.

According to an embodiment, the vehicle may include: a converter configured to convert a DC voltage to supply a portion of the power of the vehicle battery to the battery packs; and a vehicle power control part configured to control the power of the vehicle battery to prevent an excessive discharge of the vehicle battery when charging the battery packs with the power of the vehicle battery, wherein the vehicle power control part cuts off a discharge of the vehicle battery when a voltage of the vehicle battery, which is a lead-acid battery, is equal to or less than a preset threshold value.

According to an embodiment, the vehicle power control part may be configured to charge the battery packs with the power of the vehicle battery even when the vehicle is in a start-off state, but to charge the battery packs with a lower charging current than when the vehicle is in a start-on state.

According to an embodiment, the power station may further include: a controller configured to compensate a user corresponding to each of the battery packs by an amount of power discharged from the battery pack.

According to an embodiment, the controller may impose a penalty on a user upon failure to detach the discharged battery pack even after a preset time has elapsed since a discharge from the battery pack was completed.

According to an embodiment, the controller may operate a locking device to prevent detachment of the battery pack from each of the battery-mounting ports when the battery pack is discharged, and release the locking device for a battery pack that was discharged first among discharged battery packs, upon recognition of a new battery pack of another user through an interface part.

According to an embodiment, the battery pack may have a unique identification code corresponding to a user, and the controller may identify a unique identification code for the battery pack mounted in the battery-mounting port, and compensate a user corresponding to the identified unique identification code by an amount of power discharged from the battery pack.

According to an embodiment, the battery-mounting port may have a receiving space therein for accommodating the battery pack, wherein the receiving space is inclined downward toward an inside, and wherein the receiving space may be provided with a first connection terminal facing an entry direction of the battery pack entering the battery-mounting port, wherein the first connection terminal is coupled with a second connection terminal of the battery pack by the dead weight of the battery pack inserted into the battery-mounting port.

According to an embodiment, at least one perforated outlet may be formed on a lower inclined surface of the receiving space.

According to an embodiment, the power station may further include: a sealing member provided around the battery-mounting port to be in close contact with an outer surface of the battery pack inserted into the battery-mounting port.

According to an embodiment, the power station may further include: a battery status displayer configured to indicate that a battery of the battery pack mounted in the battery-mounting port has been completely discharged.

According to an embodiment, the power station may further include: a solar panel installed in a canopy form to be able to cover the plural battery-mounting ports and installed to face sun, wherein the station power control part collects power collected from the battery packs and power generated by the solar panel together.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a connection diagram centered on a power station using battery packs charged by a vehicle according to an embodiment of the present disclosure;

FIG. 2 illustrates a connection diagram of a battery pack in a vehicle and a vehicle battery for supplying power to the battery pack, according to an embodiment of the present disclosure;

FIG. 3 is a diagram illustrating the overall external appearance of a power station according to an embodiment of the present disclosure;

FIG. 4 is a diagram illustrating a state in which some battery packs are detached from the power station of FIG. 3;

FIG. 5 is a diagram illustrating a state in which the battery pack is coupled to a battery-mounting port according to an embodiment of the present disclosure;

FIG. 6 is a diagram illustrating the inside of the battery-mounting port according to an embodiment of the present disclosure;

FIG. 7 illustrates the block diagram of a power station according to an embodiment of the present disclosure;

FIG. 8 illustrates a diagram for explaining a process in which locking/unlocking of the battery pack mounted in the battery-mounting port is performed according to an embodiment of the present disclosure;

FIG. 9 is a diagram illustrating a battery-mounting port and a battery status displayer provided therearound according to an embodiment of the present disclosure; and

FIG. 10 is a diagram illustrating a solar panel connected to a power station according to an embodiment of the present disclosure.

### DETAILED DESCRIPTION OF THE DISCLOSURE

Hereinafter, the present disclosure will be described in detail by explaining exemplary embodiments of the disclosure with reference to the attached drawings. The same reference numerals in the drawings denote like elements, and a repeated explanation thereof will not be given. In addition, the suffixes “unit” and “part” of elements herein are used for convenience of description and thus can be used interchangeably and do not have any distinguishable meanings or functions. In the following description of the present disclosure, a detailed description of known functions and configurations incorporated herein will be omitted when it may make the subject matter of the present disclosure unclear. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms first, second, third etc. may be used herein to describe various elements, these elements should not be limited by these terms.

These terms are only used to distinguish one element from another element.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The expression of singularity in the present specification includes the expression of plurality unless clearly specified otherwise in the context.

Also, the terms such as “include” or “comprise” may be construed to denote a certain characteristic, number, step, operation, component, or a combination thereof in the specification, but may not be construed to exclude the presence of or a possibility of addition of one or more other characteristics, numbers, steps, operations, components, or combinations thereof.

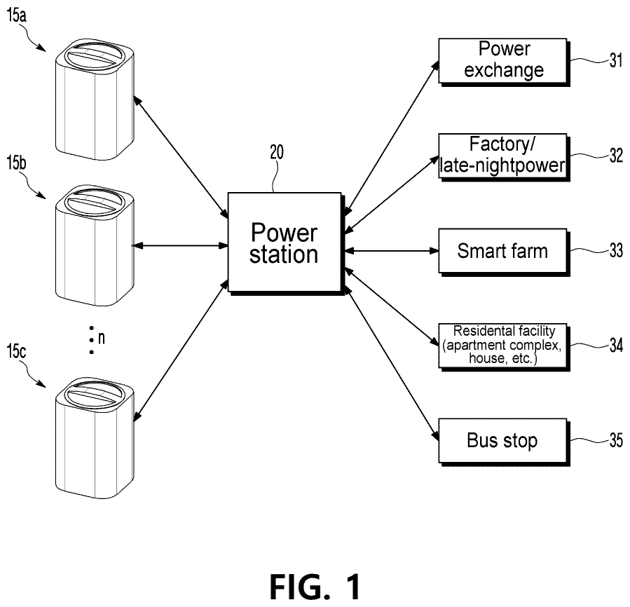

FIG. 1 illustrates a connection diagram centered on a power station using battery packs charged by a vehicle according to an embodiment of the present disclosure.

Referring to FIG. 1, a system according to an embodiment of the present disclosure includes battery packs 15 that is charged with power stored in a vehicle battery 13 provided in a vehicle 10, and a power station 20 having a plurality of battery mounting ports 22 in which the battery packs 15 are mounted. Here, the power station 20 may solve environmental problems caused by an inefficient use of energy resources by collecting surplus power generated in the vehicle 10 without waste and supplying power, collected from the plural battery packs 15, to be utilized by various external power-receiving means 31 to 35, such as a power exchange 31, a factory 32, a smart farm 33, a residential facility 34 including an apartment complex, a detached house, a multi-family house, a villa, and the like, and/or a bus stop 35.

Hereinafter, each component will be described in detail.

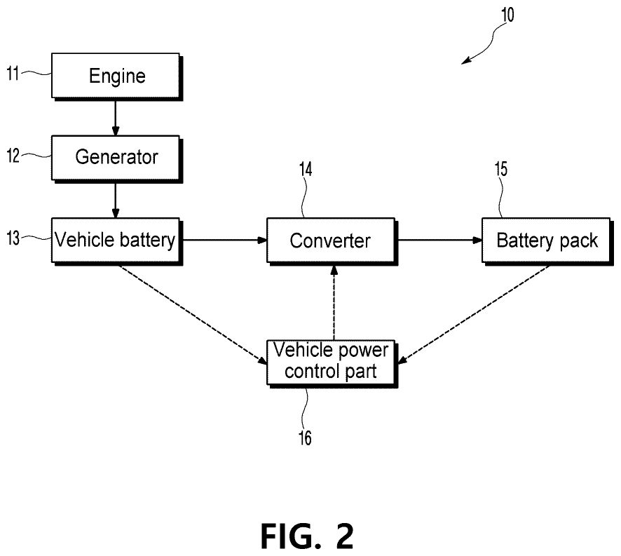

FIG. 2 illustrates a connection diagram of a battery pack in a vehicle and a vehicle battery for supplying power to the battery pack, according to an embodiment of the present disclosure.

The vehicle 10 is a vehicle that is movable by driving a motor (not shown) or an engine 11, and the type of the vehicle 10 is not particularly limited in the present disclosure.

A generator 12 in the movable vehicle 10 generates power by driving the engine 11, and at least a portion of the power generated by the generator 12 may be stored in the vehicle battery 13. The battery pack 15 may be electrically connected to the vehicle battery 13 and may be charged by being supplied with the power stored in the vehicle battery 13. In this case, the vehicle battery 13 may be a lead-acid battery, and it is preferable that the battery pack 15, which stores the power stored in the vehicle battery 13, is a lithium-ion battery having a higher energy density and a longer lifespan than the lead-acid battery, but the present disclosure is not particularly limited thereto.

After the vehicle 10 is started, power generated by the operation of the engine 11 and the generator 12 is stored in the vehicle battery 13. Even if the vehicle battery 13 stores power (a remaining amount of about 75% or more) required for the normal operation of the vehicle 10, it is preferable that the surplus power generated due to the continuous operation of the engine 11 and the generator 12 is stored in the battery pack 15 for efficient energy use. However, the surplus power may be supplied to the battery pack 15 after being charged in the vehicle battery 13.

Typically, power output from the vehicle battery 13, which is a lead-acid battery, is a 12V or 24V DC power source, and since the battery pack 15, which is a movable lithium-ion battery, may have a higher required charging voltage such as 48V or 72V, a converter 14 may be electrically connected between the vehicle battery 13 and the battery pack 15 to boost the voltage or for efficient and stable power transmission, according to an embodiment of the present disclosure.

Since the required charging voltage of the battery pack 15 is higher than the output voltage of the vehicle battery 13, the converter 14 may be a boost converter, a buck-boost converter, or the like, but the type thereof is not particularly limited in the present disclosure.

However, it is preferable that the converter 14 according to an embodiment of the present disclosure is configured to be capable of adjusting the current and/or voltage supplied from the vehicle battery 13 to the battery pack 15 according to a control command from the vehicle power control part 16.

The vehicle power control part 16 may sense a status (e.g., an output voltage, an output current, or the like) of the vehicle battery 13 and/or the battery pack 15 and may control an operation of the converter 14 according to the status of the vehicle battery 13 and the battery pack 15.

According to a specific embodiment, to prevent an excessive discharge of the vehicle battery 13 when supplying the power stored in the vehicle battery 13 to the battery packs 15, the vehicle power control part 16 may preferably cut off the power supplied from the vehicle battery 13 to the battery packs 15 when a remaining capacity of the vehicle battery 13 or an output voltage of the vehicle battery 13 is equal to or less than a preset threshold value, and may preferably supply power from the vehicle battery 13 to the battery packs 15 only when the remaining capacity of the vehicle battery 13 or the output voltage of the vehicle battery 13 exceeds the threshold value.

Here, the threshold value, which is a criterion for cutting off the discharge of the vehicle battery 13, is preferably a predetermined power level at which an electrical/electronic device can be normally used not only for starting the vehicle but also in a state where the vehicle is stopped, as a level at which the remaining capacity or the output voltage is higher than a level at which the vehicle may be started. For example, it is preferable that the remaining capacity of the vehicle battery 13 is 75% or more, and the output voltage of the vehicle battery 13 is 12.4 V to 12.6 V for a 12 V battery, or 24.8 V to 25.2 V for a 24 V battery.

That is, the vehicle power control part 16 according to an embodiment of the present disclosure may sense the status of the vehicle battery 13 and the battery packs 15. When the remaining capacity or the output voltage of the vehicle battery 13 is greater than the preset threshold value according to the status of the vehicle battery 13, the vehicle power control part 16 may supply power to the battery packs 15 through the converter 14 to charge the battery packs 15, and when the remaining capacity or the output voltage of the vehicle battery 13 is equal to or less than the preset threshold value, the vehicle power control part 16 may cut off the power supplied from the vehicle battery 13 to the battery packs 15 through the converter 14.

Meanwhile, when the power stored in the vehicle battery 13 is supplied to the battery packs 15 for charging, it is preferable that the vehicle power control part 16 according to an embodiment of the present disclosure varies a charging current according to the status of the vehicle.

Specifically, the vehicle power control part 16 may identify a start-on/off state of the vehicle 10, and accordingly, it is preferable to supply power from the vehicle battery 13 to the battery packs 15 with a relatively low charging current when the vehicle 10 is in the start-off state than when the vehicle 10 is in the start-on state. This is because when the vehicle 10 is in the start-on state, power is continuously generated by driving of the engine 11 and the generator 12 to charge the vehicle battery 13, whereas when the vehicle 10 is in the start-off state, power is not generated because the engine 11 and the generator 12 are not driven, and thus the vehicle battery 13 is not charged.

In addition, although the present disclosure is not particularly limited, the vehicle power control part 16 may store a start on/off history of the vehicle 10 over time in a storage (not shown), and may calculate a duty ratio indicating a time during which a start-on state is maintained for a predetermined arbitrary period (e.g., one week or two weeks) by using the start on/off history of the vehicle 10, and based on the duty ratio, may variably adjust a threshold value for the remaining capacity or the output voltage of the vehicle battery 13, which serves as a criterion for cutting off/supplying power supplied from the vehicle battery 13 to the battery packs 15.

Specifically, when the duty ratio is higher than the preset reference value, the vehicle power control part 16 may lower the threshold value by ΔV (e.g., an output voltage of 0.2 V) compared to the preset threshold value, and conversely, when the duty ratio is lower than the reference value, may raise the threshold value by ΔV (e.g., an output voltage of 0.2 V) compared to the preset threshold value. In this manner, by adjusting the cutoff/supply criterion for the power supplied to the battery packs 15 according to a user's vehicle driving characteristics (or vehicle driving frequency, vehicle driving time, etc.) within a predetermined period, the power supplied to the battery packs 15 may be maximized within a possible range.

Furthermore, the vehicle power control part 16 according to an embodiment of the present disclosure may repeat a series of processes of adjusting the threshold value, which is the criterion for cutting off/supplying the power supplied from the vehicle battery 13 to the battery packs 15 based on the duty ratio, at a cycle of the preset arbitrary period for calculating the duty ratio.

Meanwhile, the power station 20 according to an embodiment of the present disclosure may collect power using the plural battery packs 15 charged by the vehicle battery 13, which is a lead-acid battery, and may supply the collected power to external power-receiving means 31 to 35.

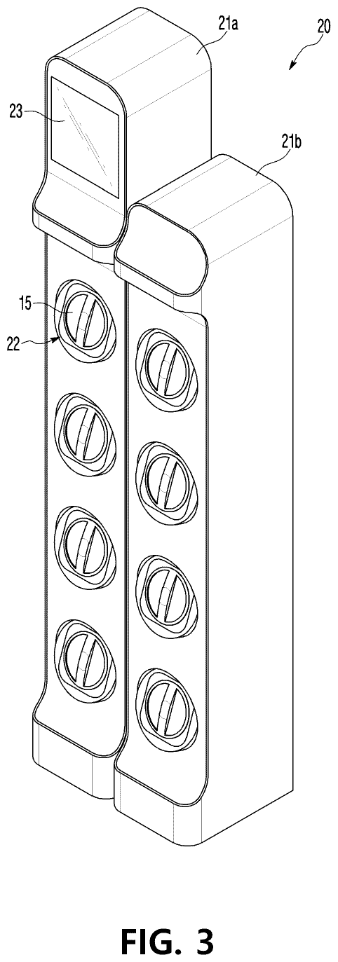

FIG. 3 is a diagram illustrating the overall external appearance of a power station according to an embodiment of the present disclosure. As illustrated in FIG. 3, the power station 20 according to an embodiment of the present disclosure may include at least one housing 21a and 21b that forms an external appearance, a plurality of battery-mounting ports 22 provided on one surface of the housings 21a and 21b, and a station power control part 25 that collects power from the battery packs 15 mounted in the battery-mounting ports 22 and supplies the collected power to the external power-receiving means 31 to 35.

Hereinafter, each component will be described.

The power station 20 according to an embodiment of the present disclosure may include the housings 21a and 21b having the battery-mounting ports 22 on one surface thereof, and the power station 20 may be formed by coupling one or more housings 21a and 21b.

Here, the shape of the housings 21a and 21b is not particularly limited in the present disclosure. As a specific example, the housings may have a rectangular shape that is elongated in one direction, and the plural battery-mounting ports 22 may be formed along a longitudinal direction of the housings 21a and 21b on one surface, specifically, on a front surface thereof. That is, a single housing 21a or 21b elongated in a vertical direction has the plural battery-mounting ports 22, and a plurality (n) of such housings 21a and 21b may be coupled in a line in a lateral direction to form the power station 20.

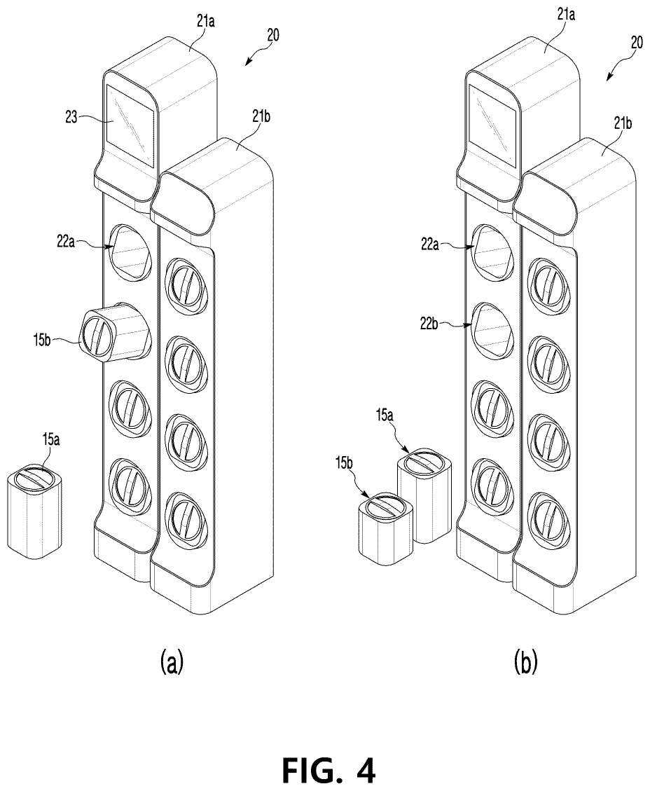

FIG. 4 is a diagram illustrating a state in which some battery packs are detached from the power station of FIG. 3. As illustrated in FIG. 4, the battery packs 15 may be mounted in the battery-mounting ports 22 of the power station 20 according to an embodiment of the present disclosure.

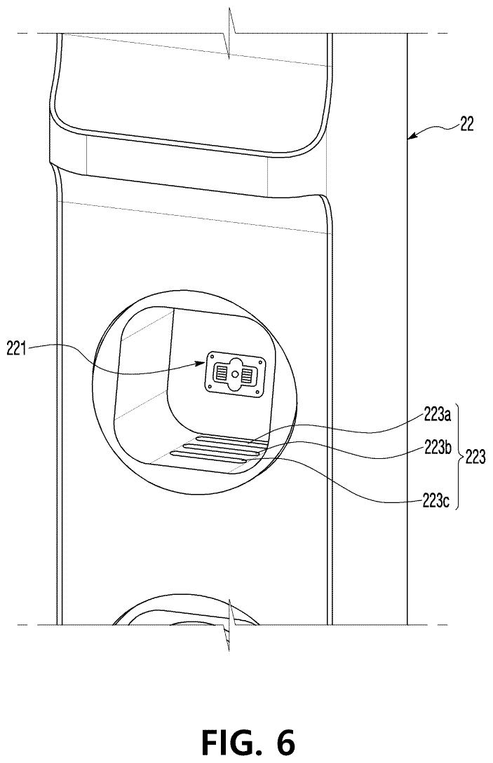

The battery-mounting port 22 may be in a shape of a groove recessed inward on one surface of the housings 21a and 21b, and may be a polygonal or circular groove corresponding to the cross-section of the battery packs 15 or battery pack cases 151. For example, when the battery packs 15 or the battery pack cases 151 have a substantially quadrangular prism shape as illustrated in FIG. 6, the battery-mounting ports 22 may also have a shape of a substantially quadrangular groove recessed inward on one surface of the housings 21a and 21b correspondingly.

As such, the battery-mounting port 22 has a receiving space therein capable of accommodating the battery packs 15, wherein the receiving space may be inclined downward toward an inside thereof. Accordingly, when the movable battery packs 15 are mounted in the battery-mounting ports 22, the battery packs 15 inserted into the battery-mounting ports 22 may move along the downwardly inclined receiving space by their dead weights to be mounted in the battery-mounting ports 22.

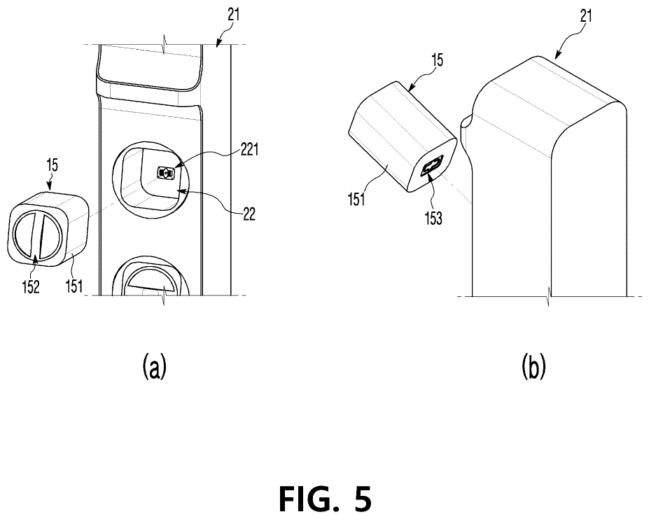

FIG. 5 is a diagram illustrating a state in which the battery pack is coupled to the battery-mounting port according to an embodiment of the present disclosure. As illustrated in FIG. 5, a first connection terminal 221 may be provided in each of the battery-mounting ports 22 according to an embodiment of the present disclosure to face an entry direction of each battery pack 15 entering the battery-mounting port 22, and correspondingly, a second connection terminal 153 capable of being coupled with the first connection terminal 221 may be provided on one surface of the battery pack 15.

The first connection terminal 221 of the battery-mounting ports 22 and the second connection terminal 153 of the battery packs 15 may be a pair of terminals that can be male-female coupled to each other, and due to the coupling of the first connection terminal 221 and the second connection terminal 153, the battery packs 15 are electrically connected to the power station 20, so that the power station 20 may collect the power stored in the battery packs 15.

In addition, the controller 24 of the power station 20 may sense whether the first connection terminal 221 and the second connection terminal 153 are connected, and may determine whether the battery packs 15 are mounted in the battery-mounting ports 22 according to whether the first connection terminal 221 and the second connection terminal 153 are connected.

As such, the battery packs 15 may be mounted in or detached from the battery-mounting ports 22 of the power station 20, and to facilitate this, a handle 152 that a user can grip may be provided on one surface of the battery packs 15. Further, it is preferable that the second connection terminal 153 is provided on another surface, which is the opposite surface facing the one surface on which the handle 152 is provided.

In addition, the battery packs 15 or the battery pack cases 151, which have a substantially polygonal prism shape, may be composed of a plurality of models having different lengths, as illustrated in FIG. 4. That is, the battery packs 15 may be composed of types such as relatively long battery packs 15a and relatively short battery packs 15b.

Accordingly, some of the plural battery-mounting ports 22 provided in the power station 20 may have different groove depths from others so that the battery packs 15 of various shapes may be mounted in the battery-mounting ports 22. That is, the power station 20 according to an embodiment of the present disclosure may include the plural battery-mounting ports 22 having receiving spaces of various lengths.

In addition, a door (not shown) for opening and closing the battery-mounting ports 22 may be provided at the battery-mounting ports 22 of the power station 20 so as not to have an open state. The door may be opened and closed by a control command of the controller 24 or may be opened by an external force from the battery packs 15 inserted into the battery-mounting ports 22, but the present disclosure does not particularly limit the implementation form of the door.

Meanwhile, when the battery packs 15 are mounted in the battery-mounting ports 22 of the power station 20 according to an embodiment of the present disclosure, it is preferable that an inner surface of the receiving space in the battery-mounting ports 22 is provided to be in contact with an outer surface of the battery packs 15 mounted therein so that the first connection terminal 221 in the battery-mounting ports 22 and the second connection terminal 153 of the battery packs 15 can be coupled to face each other.

However, when the receiving space of the battery-mounting ports 22 and the battery packs 15 are in close contact, it may be difficult to mount the battery packs 15 because air cannot escape due to air in the receiving space of the battery-mounting ports 22 when the battery packs 15 enter the receiving space. To solve this problem, at least one perforated outlet 223 may be formed in the receiving space of the battery-mounting ports 22 according to an embodiment of the present disclosure.

FIG. 6 is a diagram illustrating the inside of the battery-mounting port according to an embodiment of the present disclosure.

That is, when the battery pack 15 is inserted and mounted in close contact with the receiving space of the battery-mounting port 22, air in the receiving space of the battery-mounting port 22 may be exhausted through at least one of the outlets 223. Accordingly, when the battery pack 15 moves on its own by its dead weight along the downwardly inclined receiving space of the battery-mounting port 22, the movement of the battery pack 15 may be prevented from being hindered by compressed air in the receiving space of the battery-Mounting port 22.

Here, at least one outlet 223 may be formed in the receiving space of the battery-mounting port 22, and it is preferable that the outlet 223 is formed on a bottom surface of the downwardly inclined receiving space of the battery-mounting ports 22, i.e., on a lower inclined surface, and more preferably, on a bottom surface of an inner distal end of the receiving space.

This is because it is preferable to allow rainwater to be drained to the outside through the outlet 223 even when rainwater or the like flows into the battery-mounting ports 22. Accordingly, a pipe having a predetermined path may be connected to the outlet 223 to be in communication with the outside so that a fluid discharged from the receiving space of the battery-mounting ports 22 can be discharged to the outside. That is, it is preferable to prevent an electronic device in the power station 20 from having an electrical short due to rainwater falling through the outlet 223.

In addition, since the power station 20, specifically, the housings 21a and 21b, according to an embodiment of the present disclosure may be installed outdoors, rainwater or the like may flow into the battery-mounting ports 22. To prevent the inflow of rainwater, a sealing member (not shown) may be provided around the battery-mounting ports 22 to be in close contact with an outer surface of the battery packs 15 inserted into the battery-mounting ports 22.

A sealing member is provided on the outside of the groove-shaped battery-mounting ports 22, specifically, on the outer inner circumferential surface, and may come into close contact with the outer surface of the battery packs 15 when the battery packs 15 are mounted in the battery-mounting ports 22. In this manner, by blocking a gap formed between the battery-mounting ports 22 and the battery packs 15 when the battery packs 15 are mounted in the battery-mounting ports 22, it is possible to block rainwater or the like from flooding into the interior of the battery-mounting ports 22.

Here, the sealing member may be made of rubber, a silicone material, or the like, whose shape is deformed by an external force. Accordingly, when the battery packs 15 are mounted inside the battery-mounting ports 22, moisture and the like are wiped off by the sealing member that comes into contact with the outer surface of the battery packs 15 and are blocked from entering the interior of the battery-mounting ports 22. However, even if rainwater or the like flows into the receiving space of the battery-mounting ports 22, the rainwater is drained to the outside through the outlet 223 and the pipe connected thereto along the downwardly inclined receiving space of the battery-mounting ports 22. Accordingly, it is preferable that no liquid fluid remains inside the battery-mounting ports 22.

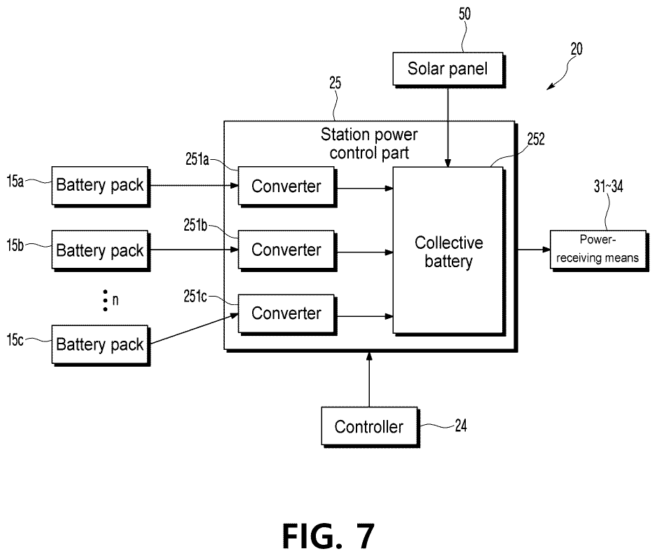

Meanwhile, FIG. 7 illustrates the block diagram of a power station according to an embodiment of the present disclosure.

As illustrated in FIG. 7, the power station 20 according to an embodiment of the present disclosure may include the station power control part 25 for supplying power collected from the plural battery packs 15 to the external power-receiving means 31 to 35.

The plural battery packs 15 mounted in the plural battery-mounting ports 22 may be connected in parallel to each other, and the power collected from the plural battery packs 15 may be stored in a collective battery 252 to be supplied to the external power-receiving means 31 to 35. The power stored in the collective battery 252 may be supplied to the external power-receiving means 31 to 35 according to a control command of the controller 24.

In this case, each of converters 251a to 251c may be provided at a rear end of each of the battery packs 15 so that the station power control part 25 stores an output of each of the battery packs 15 in the collective battery 252.

The converters 251a to 251c according to an embodiment of the present disclosure may be connected at least one-to-one with the battery packs 15 mounted in the battery-mounting ports 22, and may convert different output voltages of the battery packs 15 having different remaining capacities to be constant. To this end, the converters 251a to 251c of the station power control part 25 may adaptively convert voltages corresponding to different input voltages so that the battery packs 15 connected in parallel output a uniform output voltage.

Here, the controller 24 of the power station 20 may measure an amount of power charged from each of the battery packs 15 to the collective battery 252 or an amount of power discharged from each of the battery packs 15, and with respect to the measured amount of power, may compensate a user corresponding to the battery packs 15 by the amount of power discharged from the battery packs 15, or by the amount of power charged to the collective battery 252.

Specifically, the controller 24 may compensate the user according to the amount of power discharged from the battery packs 15 mounted in the battery-mounting ports 22 of the power station 20 or charged to the collective battery 252. That is, the greater the amount of discharge of the battery packs 15 or the amount of charge of the collective battery 252, the greater the amount of compensation to the user may be, and conversely, the smaller the amount of discharge of the battery packs 15 or the amount of charge of the collective battery 252, the smaller the amount of compensation to the user may be.

That is, it is preferable that a user charges the battery packs 15 by using the vehicle 10, mounts the charged battery packs 15 in the battery-mounting ports 22 of the power station 20, and provides the power stored in the battery packs 15, thereby being able to receive compensation accordingly. Here, the compensation may be monetary, such as an article, a gift certificate, or points.

An amount of compensation per unit of power provided by the user may be constant, but the amount of compensation according to an embodiment of the present disclosure may vary based on a price per unit of power traded at a power exchange 31. To this end, the controller 24 may be connected to the power exchange 31 through a communication means to be able to communicate therewith and receive a currently traded price per unit of power.

As such, when compensating based on the amount of discharge of the battery packs 15 or the amount of charge to the collective battery 252, it is necessary to identify the corresponding user.

The power station 20 according to an embodiment of the present disclosure may confirm that the battery pack 15 coupled to the battery-mounting port 22 belongs to a user in a logged-in state through a user's login procedure via an interface part 23. However, it is preferable that the power station 20 according to an embodiment of the present disclosure is capable of identifying a user corresponding to the battery pack 15 mounted in the battery-mounting port 22, and to this end, the battery pack 15 according to an embodiment of the present disclosure may have a unique identification code corresponding to the user. That is, the controller 24 may identify a user corresponding to the unique identification code read by using reading means 231 and 232, and may compensate the corresponding user by the amount of power discharged from the battery pack 15 or the amount of power charged to the collective battery 252. Accordingly, the controller 24 of the power station 20 may access a storage device (not shown) that stores information about the unique identification code of the battery packs 15 corresponding to the user, o r a storage device (not shown) connected to the Internet.

In addition, the unique identification code may be a barcode or a QR code exposed on an outer surface of the battery packs 15, and accordingly, the reading means 231 and 232 of the power station 20 may be a camera or a scanner for reading the barcode or the QR code. For example, the unique identification code may be provided on one surface of the battery packs 15 or around the second connection terminal 153, and the reading means 231 and 232 for recognizing the same may be provided around the battery-mounting ports 22 or around the first connection terminal 221 in the receiving space of the battery-mounting ports 22.

The present disclosure is not limited thereto, and in addition, the unique identification code may be an RFID tag or the like, and accordingly, the reading means 231 and 232 of the power station 20 may be an RFID reader or the like that outputs a radio frequency to a nearby RFID tag and receives a signal reflected from the RFID tag. Such an RFID reader may be provided in the receiving space of the battery-mounting ports 22 or therearound.

Meanwhile, the controller 24 of the power station 20 according to an embodiment of the present disclosure may determine whether a discharge from the battery packs 15 mounted in the battery-mounting ports 22 has been completed. The controller 24 may determine that the discharge of the corresponding battery packs 15 has been completed, by sensing an output voltage of the battery packs 15 mounted in the battery-mounting ports 22 or by sensing a charging current from the battery packs 15 to the collective battery 252.

In this manner, when the battery packs 15 remain mounted in the battery-mounting ports 22 and occupy the ports 22 even after the discharge of the battery packs 15 has been completed, the power station 20 may lose an opportunity to collect power from the battery pack 15 of another user. Therefore, when the battery pack 15 is not detached even after a preset time (e.g., 1 to 3 days) has elapsed since the discharge of the battery pack 15 mounted in the battery-mounting port 22 was completed, the controller 24 of the power station 20 according to an embodiment of the present disclosure may impose a penalty on a user corresponding to the battery pack 15.

According to a specific embodiment, when the discharge of the battery pack 15 is completed and the battery pack 15 is not detached even after a preset time has elapsed thereafter, the controller 24 of the power station 20 may deduct a certain value (e.g., certain points, a certain gift certificate value, etc.) over time from the compensation previously provided to the corresponding user.

Of course, in this case, after the discharge of the battery pack 15 mounted in the battery-mounting port 22 is completed, the controller 24 of the power station 20 according to an embodiment of the present disclosure may transmit an alarm signal or an alarm message to a terminal of the user of the battery pack 15 by using a communication means to request the user to collect the battery pack 15 from the power station 20.

Furthermore, according to an embodiment of the present disclosure, in a case where the compensation provided to a user for the power stored in the battery packs 15 becomes void due to a penalty imposed after a prescribed time has elapsed without detachment of the discharged battery pack 15, it is preferable for the power station 20 to allow another user to detach the battery pack 15 so that the other user may mount his/her own battery pack 15 in the battery-mounting port 22.

As described above, when a user mounts the battery pack 15 in the battery-mounting port 22 of the power station 20 such that the first connection terminal 221 and the second connection terminal 153 are connected to each other, the controller 24 of the power station 20 may determine that the battery pack 15 is mounted in the battery-mounting port 22.

When it is determined that the battery pack 15 is mounted in the battery-mounting port 22, the controller 24 of the power station 20 may operate a locking device for preventing detachment of the battery pack 15, so as to prevent the battery pack 15 from being arbitrarily detached from the battery-mounting port 22.

Here, the locking device may include a lever that rotates about an axis, and a driving means for rotating the lever about the axis. Accordingly, when the locking device is operated, the lever may rotate to be coupled to the battery pack case or to block at least a portion of an outer surface of the battery pack 15 mounted in the battery-mounting port 22, thereby preventing the battery pack 15 from being detached from the battery-mounting port 22.

As such, when the battery pack 15 is mounted in the battery-mounting port 22, the battery pack 15 is not arbitrarily detached from the battery-mounting port 22 by the operation of the locking device. However, it is preferable to allow the locking device to be released by another user, who is not the user of the battery pack 15, after the compensation according to the amount of discharge of the battery pack 15 has been forfeited by a penalty after the discharge of the battery pack 15 is completed and a certain time has elapsed.

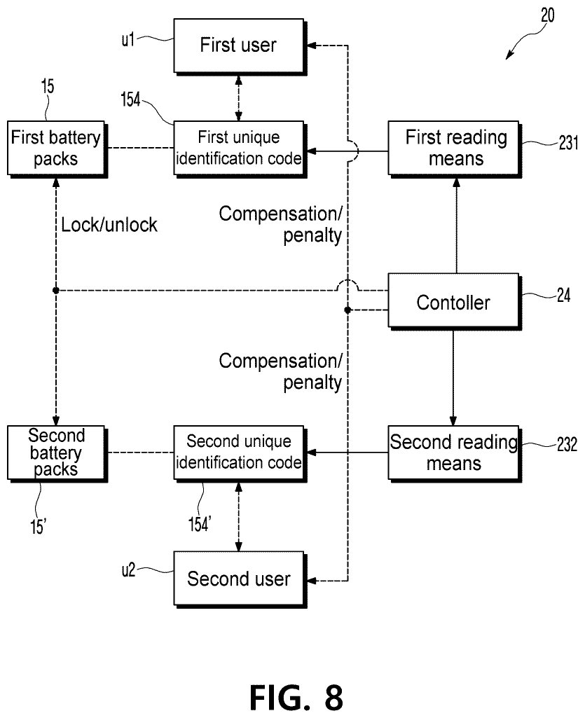

Specifically, FIG. 8 illustrates a diagram for explaining a process in which locking/unlocking of the battery pack mounted in the battery-mounting port is performed according to an embodiment of the present disclosure. As illustrated in FIG. 8, when a first battery pack 15 is mounted in any one of the battery-mounting ports 22, the controller 24 of the power station 20 may identify a first user u1 through a first unique identification code 154 of the first battery pack 15 by using a first reading means 231, and may thereafter operate the locking device to prevent detachment of the first battery pack 15 from the battery-mounting port 22. The present disclosure is not limited thereto, and a user may perform a login procedure for the user by using the interface part 23.

Thereafter, the first user u1 may detach the first battery pack 15 by releasing the locking device of the battery-mounting port 22 after going through an authentication procedure for the first battery pack 15 via a login procedure using the interface part 23. However, if the discharge of the first battery pack 15 is completed and a certain time has elapsed so that the compensation for the first user u1 is forfeited by a penalty, it is preferable to allow a second user u2, who is not the first user u1, to detach the first battery pack 15 by releasing the locking device that is in an operating state to prevent detachment of the first battery pack 15, when the second user u2 is authenticated through a login procedure using the interface part 23 or has his/her second battery pack 15′ identified through a second reading means 232 provided to face an outside of the power station 20. Here, the second reading means 232 for identifying a second unique identification code 154′ of the second battery packs 15′ may be provided on or around the interface part 23.

In this case, when the discharge of the plural battery packs 15 mounted in the plural battery-mounting ports 22 of the power station 20 is completed and a certain time has elapsed so that the compensation provided to the corresponding user has been forfeited by the imposition of a penalty due to the failure to detach the battery packs 15, and thereafter, when the second user u2, who is another user, has their new battery pack 15 recognized through the second reading means 232 of the power station 20 so as to mount his/her new battery pack 15 in the battery-mounting port 22 where the battery pack 15 with the forfeited compensation is already mounted, it is preferable to release the locking device for the battery pack 15 that were discharged first among the plural discharged battery packs 15 so that it can be detached.

However, when the second user u2, who is another user, has only one new battery pack 15, it is preferable to first release the locking device for the battery pack 15 that was discharged first, and not to release the locking device for other battery pack 15 that was discharged next in order, even if the same new battery pack 15 is repeatedly recognized multiple times through the second reading means 232 of the power station 20. That is, it is preferable that the locking devices are released for as many of new battery packs 15 (excluding duplicates), recognized by the power station 20, among the plural battery packs 15 whose compensation granted according to the amount of discharge has been forfeited by the imposition of a penalty.

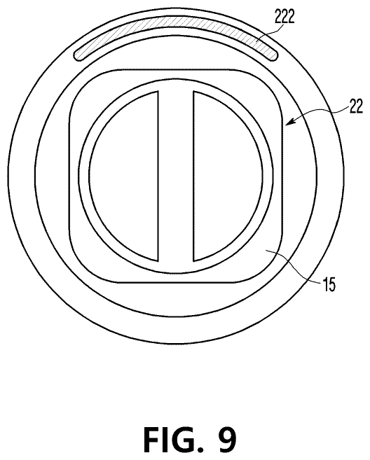

Meanwhile, FIG. 9 is a diagram illustrating a battery-mounting port and a battery status displayer provided therearound according to an embodiment of the present disclosure. As illustrated in FIG. 9, a battery status displayer 222 for indicating that the discharge of the battery pack 15 mounted in the battery-mounting port 22 has been completed may be provided around each of the battery-mounting ports 2 of the housings 21a and 21b according to an embodiment of the present disclosure.

When the output voltage of the battery pack 15 mounted in the battery-mounting ports 22 is equal to or less than the preset threshold value, the controller 24 of the power station 20 according to an embodiment of the present disclosure may use the battery status displayer 222 provided around the corresponding battery-mounting ports 22 to output to the outside that the discharge of the corresponding battery packs 15 has been completed.

That is, it is preferable to allow a user to intuitively recognize the position of the battery pack 15 that the user desires to detach because its discharge has been completed.

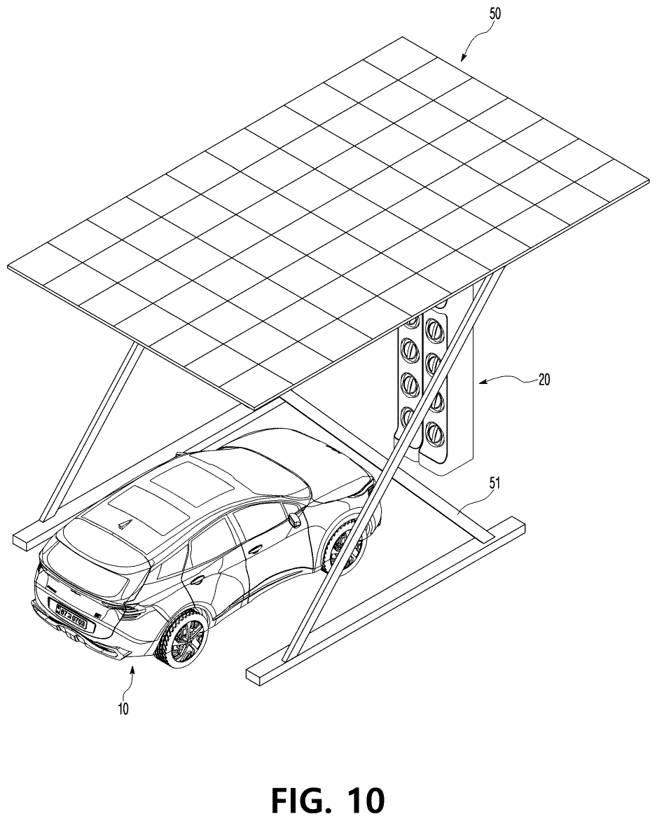

Meanwhile, FIG. 10 is a diagram illustrating a solar panel connected to a power station according to an embodiment of the present disclosure.

As illustrated in FIG. 10, the power station 20 according to an embodiment of the present disclosure may further include a solar panel 50 installed in a canopy form to cover the housings 21a and 21b, specifically, the plural battery-mounting ports 22, and installed to face the sun.

Accordingly, the solar panel 50 is provided to be spaced apart from the ground by at least one support 51, and the power station 20 may be located therebelow. As such, the solar panel 50 is a device for converting sunlight into electricity, and is installed to face the sun and to cover the housings 21a and 21b from a spaced-apart upper position, thereby being able to block foreign substances or the like from entering the housings 21a and 21b.

In addition, the station power control part 25 may collect power collected from the plural battery packs 15 and power generated by the solar panel 50 together in the collective battery 252, and may supply the power collected in the collective battery 252 to the external power-receiving means 31 to 35.

In this case, although not illustrated in the drawings, a converter for adjusting a voltage and/or a current may be included to store the power generated from the solar panel 50 in the collective battery 252. The converter provided between the solar panel 50 and the collective battery 252 may correspond to an output voltage of the converters 251a to 251c provided between the battery packs 15 and the collective battery 252.

As described above, the controller 24 of the power station 20 may compensate a user according to an amount of discharge of the battery pack 15 or an amount of charge to the collective battery 252, and it is preferable to compensate an operator for an amount of charge to the collective battery 252 generated by the solar panel 50, so that the operator maintains the power station 20.

A power station according to the present disclosure can solve environmental problems caused by the inefficient use of energy resources by collecting surplus power generated in a vehicle and supplying the collected surplus power to external power-receiving means.

In addition, when collecting surplus power at a power station, participation of users can be induced by providing compensation to a user who provides surplus power, and conversely, unauthorized occupation of a battery-mounting port by a user can be prevented by imposing a penalty on the user for failure to detach a battery pack mounted in the power station.

Furthermore, when charging the battery pack with power stored in a vehicle battery, a discharge of the vehicle battery can be prevented by controlling the charging speed and the like.

Moreover, even if a sealing member is provided at the battery-mounting ports of the power station to form a watertight state, attachment and detachment of the battery packs to and from the battery-mounting ports can be facilitated.

The preferred embodiments of the present disclosure have been described in detail above with reference to the accompanying drawings. However, this description is provided by way of example only. Those skilled in the art to which the present disclosure pertains will appreciate that various modifications and other specific forms can be made without departing from the technical spirit or essential features of the disclosure.

Therefore, the scope of the present disclosure should be defined not by the foregoing detailed description, but by the accompanying claims. It is to be understood that all modifications or variations derived from the meaning, scope, and equivalents of the claims are included within the scope of the present disclosure.

### DESCRIPTION OF SYMBOLS

10: vehicle 11: engine
12: generator 13: vehicle battery
14: converter 15: battery pack
151: battery pack case 152: handle
153: second connection terminal 16: vehicle power control part
20: power station 21a, 21b: housing
22: battery-mounting ports 221: first connection terminal
222: battery status displayer 23: interface part
31˜35: power-receiving means 50: solar panel
51: supporter

What is claimed is:

1. A power station using battery packs charged by a vehicle, the power station comprising:
a plurality of battery-mounting ports in which mobile battery packs are mounted; and
a station power control part configured to collect power from the plural battery packs and supply the collected power to an external power-receiving means,
wherein the battery packs are connected to a vehicle battery that stores power generated by driving of an engine by a generator of a vehicle, and are charged with the power of the vehicle battery.

2. The power station according to claim 1, wherein the vehicle comprises:
a converter configured to convert a DC voltage to supply a portion of the power of the vehicle battery to the battery packs; and
a vehicle power control part configured to control the power of the vehicle battery to prevent an excessive discharge of the vehicle battery when charging the battery packs with the power of the vehicle battery,
wherein the vehicle power control part cuts off a discharge of the vehicle battery when a voltage of the vehicle battery, which is a lead-acid battery, is equal to or less than a preset threshold value.

3. The power station according to claim 2, wherein the vehicle power control part is configured to charge the battery packs with the power of the vehicle battery even when the vehicle is in a start-off state, but to charge the battery packs with a lower charging current than when the vehicle is in a start-on state.

4. The power station according to claim 1, further comprising: a controller configured to compensate a user corresponding to each of the battery packs by an amount of power discharged from the battery pack.

5. The power station according to claim 4, wherein the controller imposes a penalty on a user upon failure to detach the discharged battery pack even after a preset time has elapsed since a discharge from the battery pack was completed.

6. The power station according to claim 5, wherein the controller operates a locking device to prevent detachment of the battery pack from each of the battery-mounting ports when the battery pack is discharged, and releases the locking device for a battery pack that was discharged first among discharged battery packs, upon recognition of a new battery pack of another user through an interface part.

7. The power station according to claim 4, wherein the battery pack has a unique identification code corresponding to a user, and the controller identifies a unique identification code for the battery pack mounted in the battery-mounting port, and compensates a user corresponding to the identified unique identification code by an amount of power discharged from the battery pack.

8. The power station according to claim 1, wherein the battery-mounting port has a receiving space therein for accommodating the battery pack, wherein the receiving space is inclined downward toward an inside, and
wherein the receiving space is provided with a first connection terminal facing an entry direction of the battery pack entering the battery-mounting port, wherein the first connection terminal is coupled with a second connection terminal of the battery pack by a dead weight of the battery pack inserted into the battery-mounting port.

9. The power station according to claim 8, wherein at least one perforated outlet is formed on a lower inclined surface of the receiving space.

10. The power station according to claim 9, further comprising: a sealing member provided around the battery-mounting port to be in close contact with an outer surface of the battery pack inserted into the battery-mounting port.

11. The power station according to claim 1, further comprising: a battery status displayer configured to indicate that a battery of the battery pack mounted in the battery-mounting port has been completely discharged.

12. The power station according to claim 1, further comprising: a solar panel installed in a canopy form to be able to cover the plural battery-mounting ports and installed to face sun,
wherein the station power control part collects power collected from the battery packs and power generated by the solar panel together.
